(19) United States
(12) Patent Application Publication
(10) Pub. No.: US 2022/0164402 A1
(43) Pub. Date: May 26, 2022

(54) ENHANCING THE ACCURACY OF SEARCH RESULTS

(71) Applicant: Flipkart Internet Private Limited, Bangalore (IN)

(72) Inventors: Jayesh Bageriya, Madhya Pradesh (IN); Azad Krishna Tripathi, Rajasthan (IN); Harshit Pandey, Bangalore (IN)

(21) Appl. No.: 17/535,791

(22) Filed: Nov. 26, 2021

(30) Foreign Application Priority Data
Nov. 26, 2020 (IN) 202041051599

(51) Int. Cl. G06F 16/9532

(52) U.S. Cl. CPC G06F 16/9532; G06Q 30/0625

(57) ABSTRACT

A selection gap for a user query on an e-commerce website is determined. The selection gap is said to exist when a product for a user search query does not exist in the e-commerce website. When a selection gap for the user search query exists, keywords in the user's search query is identified and at least one keyword in the user search query is replaced with a relevant alternate keyword. Based on the new keyword, a new search query is generated. Search results are generated based on new search query.

### FIELD OF INVENTION

Embodiments of the present application illustrate a system and method for performing searches on an e-commerce website.

### BACKGROUND OF THE INVENTION

While shopping on an e-commerce website, a user enters a query for a product and the e-commerce website displays relevant products for the user's query. The query entered by the user generally comprises either brand name and/or price and/or color etc. The e-commerce website looks into the database and finds a product matching the user's query and displays the same for the user who can thereafter proceed with the purchase.

However, it is possible that sometimes an e-commerce website may not have the exact brand or type of the product the user is looking for. It is possible that the brand or color, which the user is looking for, is not available on the e-commerce store. In such a situation the e-commerce website returns very irrelevant results which does not match the user's query. This may dissuade a user from shopping on the e-commerce website.

Also, in such cases, it may be possible that similar products may be available in some other brands or in some other color. For example, a user is searching for Adidas sports shoes and a particular e-commerce does not have the Adidas shoes but have similar shoes from Nike. In such cases, instead of showing similar shoes from Nike, in response to the query, the state of the art e-commerce website may show a formal leather shoe which is irrelevant to the user's query. Thus, instead of returning the similar relevant results, the state of the art e-commerce website provides results which are very irrelevant for the user query.

### SUMMARY OF THE INVENTION

The following presents a simplified summary of the subject matter in order to provide a basic understanding of some of the aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

The present invention discloses a system and method for enhancing search results on an e-commerce website.

According to the present subject matter, it is determined if a product corresponding to a user search query exists or not in the e-commerce database. When a product corresponding to a user search query does not exist in the database of an e-commerce site, a selection gap is said to exist. When there is a selection gap for the user search query, the user search query is analyzed and the user search query is modified into a new search query for which some relevant products exist on the e-commerce website.

To generate a new search query based on the user search query, the keywords of the user search query is analyzed and at least one keyword is replaced with a possible alternate keyword to create a new search query. The possible alternate keyword is synonymous to the keyword that has been replaced. The new search query is relevant to the previous user search query with some changes in the attributes, such as brand name, color etc. The new search query is generated based on a knowledge graph stored in a database. The knowledge graph is periodically created based on external data stored in the database. The knowledge graph indicates relevant alternatives for keywords of the user search query. For example, when a user enters a query Ray-Ban sunglasses under INR 30000′ and it is detected that there is a selection gap and Ray-Ban sunglasses are not available, a selection gap is determined to exist. A new search query is built, which is relevant to the user search query, with some changes in the keyword, and based on the product available on the e-commerce website. For example, the new search query may be generated as ‘Ralph sunglasses under INR 30000’ as the brand ‘Ralph’ is available on the e-commerce website. Thus, in the example above, a new search query which is similar to the previous query is generated by changing the brand name, in the user search query, to a different brand which is available on the e-commerce website.

Further, the new search query is used to generate search results. The search results are displayed to the user. Considering the example above, e-commerce would display the Ralph sunglasses instead of Ray-ban sunglasses.

Thus, the present subject matter displays relevant results for the user when a selection gap exists. A user would get more relevant results for a search query for which selection gap exists. This would enhance the shopping experience of the user.

### BRIEF DESCRIPTION OF THE ACCOMPANYING DRAWINGS

The following drawings are illustrative of particular examples of the present disclosure and are not intended to limit the scope of the invention. The drawings are not to scale (unless so stated) and are intended for use in conjunction with the explanations in the following detailed description.

FIG. 1 shows a system 100 for enhancing search results on an e-commerce website in accordance with an example implementation of the present subject matter.

FIG. 2 shows a system 200 for generating knowledge graphs in accordance with an example implementation of the present subject matter.

FIG. 3 shows a method 300 for enhancing search results on an e-commerce website in accordance with an example implementation of the present subject matter.

Persons skilled in the art will appreciate that elements in the figures are illustrated for simplicity and clarity and may represent both hardware and software components of the system. Further, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION

Exemplary embodiments now will be described. The disclosure may, however, be embodied in many different forms and should not be construed as limited to the embodiments set forth herein; rather, these embodiments are provided so that this disclosure will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

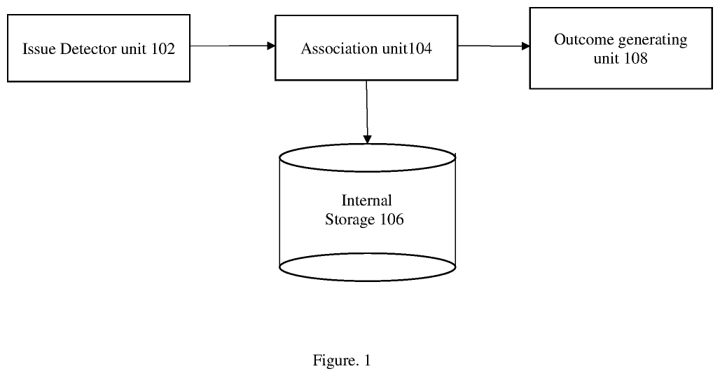

FIG. 1 shows a system 100 for enhancing search results in an e-commerce website. The system 100 comprises an issue detector unit 102 which analyzes a user search query entered by a user to determine if a product corresponding to the search query is available or not. If the issue detector unit 102 detects that the product corresponding to the user search query is not available, the issue detector unit 102 determines that a selection gap exists for the user search query.

In an example for determining the selection gap, structured product count calls may be used. Given a query, the user intent of the user search query is identified by tagging keywords of the user search query with catalog attributes available on the database of the e-commerce website. Thereafter, a number of products satisfying the user search query is determined. If the resultant product count satisfying the user query is below a predetermined threshold, a selection gap for the user search query is said to exist. In an example, the predetermined threshold may be zero or one.

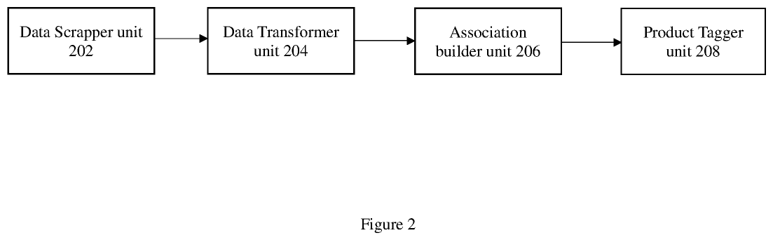

When it is determined that a selection gap exists for a user search query, the issue detector unit 102 refers the user search query to an association unit 104. The association unit 104 analyzes keywords of the query and builds a new search query based on knowledge graphs stored in an internal storage 106. The knowledge graphs are generated based on the data extracted from internal and external sources. The knowledge graphs indicate best possible alternative new keywords corresponding to the keyword entered by the user in the user search query. Details about generation of knowledge graphs have been explained with reference to FIG. 2.

After referring to the knowledge graph, the association unit 104 generates a new search query based on the user query. The new search query indicates best alternative products (relevant to the user search query) available on the e-commerce website. For generating the new search query, the association unit 104 determines the keywords of the user search query which needs to be replaced with an alternative keyword. For example, the association unit 104 may determine that a brand name in the user's search query is not available on the e-commerce website. Thus, the brand name needs to be replaced by some other alternative brand name which is available on the e-commerce website. The association unit 104 searches around, in the knowledge graph, the brand name entered by the user and determines attributes such as the brand's price range, type of product. Based on the attributes the association unit 104 determines an alternative brand. Based on the new brand name, the association unit 104 generates a new search query having new keywords (having the alternative brand name and other attributes, such as price, type of product etc). In another example, if a color for a product entered in the user search query is not available, the association unit 104 may generate a new search query having a possible alternative color. The association unit 104 replaces only those keyword for which there is no possible match on the database of the e-commerce website.

For example, a user may enter a search query ‘Quechua jacket under 5000’ in an e-commerce website search bar. The issue detector unit 102 detects that a selection gap exists for this search query (Quechua jacket is not sold on this particular e-commerce website). However, Quechua jackets are available on the web. The issue detector unit 102 refers the search query to the association unit 104. The association unit 104 determines that the keyword ‘Quechua’ needs to be replaced and the keywords ‘jacket under 5000’ needs not to be replaced as jackets under 5000 are available on the e-commerce website. The association engine 104 accesses the internal storage 106 and scans the knowledge graph to find alternatives to the keywords ‘Quechua’. Based on the knowledge graph, which has the information that Quechua usually sells hiking jackets, the association unit 104 detects an alternative keyword ‘Wildcraft’ (which also sells hiking jackets under 5000) for ‘Quechua’ and builds a new search query ‘Wildcraft jackets under 5000’. In an example, more than one alternate brand may be identified by the association unit 104 and may be used for generating new search query.

Based on the new search query an outcome generator unit 108 generates search results. The search results are the possible alternatives for the products searched by the user. The outcome generator unit 108 also ranks the search results in an order based on the similarity of the product with the user search query. The product having highest similarity is ranked at top followed by other products. In the above example, the outcome generator 108 unit may provide the user with the search results for the ‘Wildcraft hiking jackets’. In another example, if other alternate brands are identified by the association unit 104, the relevant products of those brands may also be displayed.

FIG. 2 discloses a system 200 for generating knowledge graph in accordance with an example implementation of the present subject matter.

A product listing of a particular e-commerce website is limited to a catalogue available on the particular e-commerce website. Thus, in order to understand the user's search query which may include a keyword, such as a brand which is not available on a particular e-commerce website, external data needs to be captured. These data are processed and used to determine the user intent's in a user search query. A data scraper unit 202 collects data from external databases. The data includes details of various product listings on multiple e-commerce websites and other such online stores. The attributes of product listings are represented as key:value pairs.

The data scraper unit 202 provides the captured data to a data transformer unit 204. The data transformer unit 204 transforms the data into a format understandable by the e-commerce website. As understood, the data collected from the external databases may be in some other format which may be not understood by the e-commerce website. Thus, the data transformer unit 204 converts the data into a format recognizable by the e-commerce website.

The association builder unit 206 builds an association between the data collected from the external databases and the keywords available on the e-commerce website. The association may be made between similar brands, similar colors, similar types of products etc. For example, if a user searches for a brand A, the data scraper unit may search the external databases for similar brands corresponding to the brand A. The data scraper unit 202 may derive details of various similar brands and provide the derived data to the data transformer unit 204. The data transformer unit 204 may transform the data into a format understood by the e-commerce website. The association builder unit 206, thereafter, builds an association between various brands (similar to brand A) and the brand A. Similarly, various kinds of associations is made over the time. The associations are updated regularly in a predefined period of time. The associations may be based on price, type of product, brand, color etc. In an example, for color to color association RGB representation of the colors may be used to make an association between similar colors.

A product tagger unit 208 tags each keyword of user search query with a product attribute which is understandable by the association unit 104. Each user search query keyword has a relevant product attribute tagged to it, for example ‘Nike’ keyword in a user search query will be tagged with the attribute ‘Brand’. The product attributes along with their associations with each other are referred to as knowledge graph. The associations are relations between two product attributes and can be of multiple types such as ‘similar’, ‘belong to the same product’ etc. The generated knowledge graph is stored in a storage, such as the internal storage 106. The knowledge graphs are periodically generated and stored in the storage. The association unit 104 and the outcome generator unit 108 uses the knowledge graph to find alternative keywords for the keywords entered in the user search query in case of a selection gap. Based on the alternative keywords a new search query is generated and the outcome generator unit 108 generates an output based on the keywords of the new search query. The output is a list of products tagged to the new keywords (of the new query) in the knowledge graph. Finally, the output is displayed to the user.

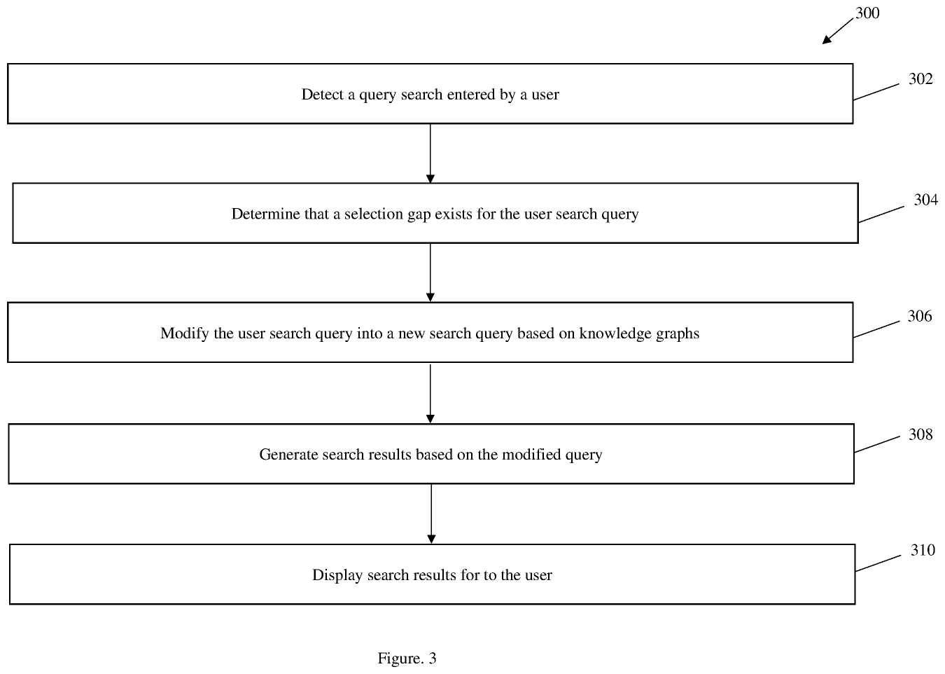

FIG. 3 shows a method 300 for enhancing search results on an e-commerce website. It should be understood that the method steps are shown as a reference only and sequence of the method steps should not be construed as limitation. The method steps can include any additional steps in any order. Although, the method 300 may be implemented in any system, the example method 300 is provided in reference to the system 100 for ease of explanation.

At block 302, a user search query entered by a user on an e-commerce website is detected. A user may enter a user search query for finding a desired product on the e-commerce website. At block 304 it is determined that a selection gap exists for the user search query. Selection gap means that the product that the user is looking for is not available on the e-commerce website. For example, the user may be looking for Nike shoes and the Nike brand may not be available on the e-commerce website. Thus, a selection gap for the user search query is said to exist.

At block 306, the user search query is modified to a new search query based on knowledge graphs. For example, a user enters a search query ‘Oneplus 7T 8 gb RAM 256 GB ROM’ on an e-commerce website and it is identified that the e-commerce website does not sell ‘Oneplus’ brand. Thus, a selection gap exists for the user search query. Based on the knowledge graph an alternative brand, such as Oppo, which is similar to ‘Oneplus’ is determined. Further, the keyword ‘Oneplus’ is replaced by the keyword ‘Oppo’ and the new search query is generated as ‘Oppo 7T 8 gb RAM 256 GB ROM’.

At block 308, search results are generated based on the new search query. In above example, the search result comprises smart phones of ‘Oppo’ having 8 gb RAM and 256 gb ROM. At block 310, the search results are displayed for the user. The search results may be ranked in decreasing order of relevance with the most relevant product at the top. Thus, even if the brand searched by the user is not available on the e-commerce website, the user is provided with best possible alternatives. Thus, the user experience is improved.

In the specification, there has been disclosed exemplary embodiments of the invention. Although specific terms are employed, they are used in a generic and descriptive sense only and not for purposes of limitation of the scope of the invention.

We claim:

1. A method of generating results for a user search query, the method comprising:
detecting a user search query entered by a user, wherein the user search query comprises a plurality of keywords;
determining that a selection gap exists for the user search query entered by the user, wherein a selection gap is said to exist, when an outcome corresponding to the user search query does not exist on an internal database;
modifying the user search query into a new search query by replacing at least one keyword of the user search query by a new keyword;
generating search results based on the new user search query.

2. The method as claimed in claim 1, wherein the at least one keyword and the new keyword are synonymous.

3. The method as claimed in claim 1, wherein the at least one keyword and the new keyword are replaced based on a knowledge graph, wherein the knowledge graphs maps relation between a plurality of keywords.

4. The method as claimed in claim 3, wherein the knowledge graph is created based on keywords extracted from internal and external databases.

5. The method as claimed in claim 4, wherein the knowledge graph is periodically updated after a predetermined period of time.

6. A system to generate results for a user search query, the system comprising:
an issue detector unit to detect that a selection gap exists for the user search query entered by a user, wherein a selection gap is said to exist, when an outcome corresponding to the user search query does not exist on an internal storage, and wherein the user search query of the user comprises a plurality of keywords;
an association unit to:
determine at least one keyword of the user search query which can be replaced by a similar new keyword to generate a new search query for which an outcome is expected to be available on the internal storage;
replace the determined at least one keyword by the new keyword to create a new search query;
an outcome generating unit to generate results based on the new search query.

7. The system as claimed in claim 6, wherein the association building unit replaces the determined at least one keyword by the new keyword based on knowledge graph, wherein the knowledge graphs maps relation between a plurality of keywords.

8. The system as claimed in claim 7 wherein the knowledge graph is created based on keywords extracted from internal and external databases.

9. The system as claimed in claim 8, wherein the knowledge graph is periodically updated in a predetermined period of time.

10. The system as claimed in claim 6, wherein the outcome generating unit ranks the results based on a relevance of a result with respect to the new search query.
